(19) United States
(12) Patent Application Publication
(10) Pub. No.: US 2019/0297159 A1
(43) Pub. Date: Sep. 26, 2019

(54) INTERNET OF THINGS SYSTEM AND METHOD FOR PUSHING MESSAGE

(71) Applicant: HEIMAVISTA INC., Taipei (TW)

(72) Inventor: Ching-Kang LEE, Taipei (TW)

(21) Appl. No.: 16/263,216

(22) Filed: Jan. 31, 2019

Related U.S. Application Data
(60) Provisional application No. 62/646,069, filed on Mar. 21, 2018.

(51) Int. Cl. H04L 29/08; H04W 4/80; H04W 4/12

(52) U.S. Cl. CPC H04L 67/26; H04W 4/12; H04W 4/80; H04L 67/125

(57) ABSTRACT

The invention provides an internet of things system and method for pushing message, which comprises a hardware device, an electronic communication device, and a remote server. The hardware device comprises a first short distance communication module. The electronic communication device comprises a second short distance communication module, a storage module for storing an application program, and a display unit. When the application program is starting, an operation interface of the application program will present on the display unit. The application program can execute a wireless communication connection process between the first short distance communication module and the second short distance communication module. Before the wireless communication connection process is finished, at least one message pushed by the remote server will present on the operation interface of the application program; after the wireless communication connection process has finished, the remote server stops to push the message.

This non-provisional application claims priority claim under 35 U.S.C. § 119 (a) on U.S. Provisional Application No. 62/646,069 filed Mar. 21, 2018, the entire contents of which are incorporated herein by reference.

### FIELD OF THE INVENTION

The present invention relates to a pushing message system and method, particularly to an internet of things system and method for pushing message.

### BACKGROUND

Internet of things technology is the focus of science and technology development in the new generation. Many manufacturers are actively investing in related research and product development. The internet of things system usually comprises an electronic communication device and a hardware device. The electronic communication device is able to install an application program (APP) capable of controlling the operation of the hardware device. The electronic communication device can establish a wireless communication connection between the electronic communication device and the hardware device by the application program. After the wireless communication connection is established, the electronic communication device may perform related settings to the hardware device or control the actions of the hardware device by the interface operation of the application program.

Besides, when the electronic communication device establishes a wireless communication connection with the hardware device by the use of the application program, it needs to wait for a connection time so that the wireless communication connection can be successfully established. While waiting for the connection time, the user of the electronic communication device can usually have no choice but to watch the connection frame on the screen of the electronic communication device.

For the above reason, the present invention provides a means of pushing message in the internet of things system, in which can push at least one message to the electronic communication device and present the message on the operation interface of the application program of the electronic communication device during the establishment of a wireless communication connection between the electronic communication device and the hardware device, so that the user of the electronic communication device can view at least one pushed message before waiting for the wireless communication connection to complete, which will be the objective of this invention.

### SUMMARY

It is one objective of the present invention to provide an internet of things system for pushing message, which comprises a hardware device, an electronic communication device, and a remote server. The electronic communication device comprises an application program. The electronic communication device executes a short distance wireless communication connection process between the electronic communication device and the hardware device by the application program. Before the short distance wireless communication connection process finishes, at least one message pushed by the remote server will be presented on the operation interface of the application program. The remote server stops to push the message after the wireless communication connection process has finished.

It is another objective of the present invention to provide an internet of things system for pushing message, in which the hardware device is configured with a unique identification code. When the application program of the electronic communication device is in executing the wireless communication connection process, the electronic communication device receives the unique identification code sent from the hardware device and transmits the unique identification code to the remote server, the remote server selects the message to be pushed according to the unique identification code and pushes the selected message to the electronic communication device.

It is another objective of the present invention to provide an internet of things system for pushing message, when the application program of the electronic communication device starts, a login screen will be presented on the operation interface of the application program, a login account can be entered on the login screen by the user of the electronic communication device and transmitted to the remote server. After the remote server confirms an identity and background information of the user of the electronic communication device according to the login account, the remote server selects the message to be pushed according to the identity and background information of the user, and push the selected message to the electronic communication device.

It is another objective of the present invention to provide an internet of things system for pushing message, in which the internet of things system is provided with multiple versions of the application programs. The electronic communication device can install a specific version of application program. When the electronic communication device is in executing the wireless communication connection process by the specific version of application program, the remote server will select the message to be pushed based on the application program's version installed in the electronic communication device, and push the selected message to the electronic communication device.

It is another objective of the present invention to provide an internet of things system for pushing message, which is configured with a business mechanism of pushing message. The business mechanism will provide a pushing message service for merchant in the way of stored value points. The remote server records the stored value points of the merchant. When the remote server pushes the message of merchant to the electronic communication device, it will counts the number of times of pushing the message of the merchant, and deducts the relative stored value points of the merchant according to the number of times of pushing the message of the merchant.

For achieving the above objectives, the present invention provides an internet of things system for pushing message, comprising: at least one electronic communication device comprising a processor, a first short distance communication module, a network communication module, a storage module, and a display unit, wherein the processor is connected to the first short distance communication module, the network communication module, the storage module, and the display unit, the storage module stores at least one application program, an operation interface of the application program is presented on the display unit when the application program starts; at least one hardware device comprising a microcontroller and a second short distance communication module, wherein the microcontroller is connected to the second short distance communication module, the electronic communication device communicates with the hardware device via the first short distance communication module and the second short distance communication module, the application program of the electronic communication device is capable of controlling the operation of the hardware device; and a remote server, wherein the electronic communication device is connected to the remote server via the network communication module; wherein when the application program of the electronic communication device is in executing a short distance wireless communication connection process between the electronic communication device and the hardware device, at least one message will be pushed to the electronic communication device by the remote server and presented on the operation interface of the application program.

In one embodiment of the present invention, the hardware device is configured with a unique identification code, when the application program of the electronic communication device is in executing the short distance wireless communication connection process between the electronic communication device and the hardware device, the electronic communication device will receive the unique identification code from the hardware device and transmits the unique identification code to the remote server, the remote server will select the message to be pushed according to the unique identification code, and transmit the selected message to the electronic communication device.

In one embodiment of the present invention, the unique identification code is a physical address of the second short distance communication module, or a product serial number of the hardware device, or an identification number written to the hardware device by a manufacturer.

In one embodiment of the present invention, the remote server comprises a plurality of message databases, each of message databases records a plurality of the unique identification codes and stores the at least one message, when the remote server receives the unique identification code from the electronic communication device, the remote server will determine the corresponding message database in which the received unique identification code is recorded, extract the at least one message from the corresponding message database in which the received unique identification code is recorded, and push the extracted message to the electronic communication device.

In one embodiment of the present invention, the remote server comprises a member database, the member database records a plurality of members' identities and background information, when the application program of the electronic communication device starts, a login screen will be presented on the operation interface of the application program, a login account can be entered on the login screen and transmitted to the remote server, the remote server can confirm an identity and background information of the electronic communication device's user according to the login account, select the message to be pushed according to the identity and background information of the electronic communication device's user, and transmit the selected message to the electronic communication device.

In one embodiment of the present invention, the internet of things system is provided with multiple versions of the application programs, the electronic communication device is able to install one specific version of the application program, when the electronic communication device is in executing the short distance wireless communication connection process between the electronic communication device and the hardware device by the specific version of application program installed, the remote server will select the message to be pushed based on the application program's version installed in the electronic communication device, and push the selected message to the electronic communication device.

In one embodiment of the present invention, the remote server comprises a message pushing management module and a point database, the point database records stored value points of each of merchants, when the remote server pushes the at least one message of a specific merchant to the at least one electronic communication device, the message pushing management module counts the number of times of pushing the message of the specific merchant, and deducts the relative stored value points of the specific merchant in the point database according to the number of times of pushing the message of the specific merchant.

In one embodiment of the present invention, the message is an advertisement message or a notification message.

In one embodiment of the present invention, the message is a message of text format, sound format, or video format.

In one embodiment of the present invention, the hardware device is a self-photographing device, a smart home appliance, a Bluetooth speaker or other smart electronic device.

In one embodiment of the present invention, the first short distance communication module or the second short distance communication module is a Bluetooth communication module, a WiFi communication module or a component capable of short-distance communication.

In one embodiment of the present invention, the network communication module is a 3G or 4G communication module, a WiFi communication module, or a communication module capable of connecting network.

The present invention further provides a method for pushing message, which is applied in an internet of things system, the internet of things system comprises at least one electronic communication device, at least one hardware device, and a remote server, the electronic communication device comprises a display unit and stores an application program, steps of the method for pushing message comprising: starting the application program of the electronic communication device to present an operation interface of the application program on the display unit of the electronic communication device; establishing a connection between the electronic communication device and the remote server in a means of network connection; executing a short distance wireless communication connection process by the application program of the electronic communication device; and pushing at least one message to the electronic communication device by the remote server and presenting the at least one message on the operation interface of the application program when the application program of the electronic communication device is in executing a short distance wireless communication connection process between the electronic communication device and the hardware device.

### BRIEF DESCRIPTION OF THE DRAWINGS

FIG. 1 is a structural diagram of an internet of things system according to one embodiment of the present invention.

FIG. 2 is a circuit structure diagram of an electronic communication device according to one embodiment of the present invention.

FIG. 3 is a circuit structure diagram of a hardware device according to one embodiment of the present invention.

FIG. 4 is a schematic diagram of a message presented on the operation interface of the application program of the present invention.

FIG. 5 is a schematic diagram of a login screen presented on the operation interface of the application program of the present invention.

### DETAILED DESCRIPTION OF THE PREFERRED EMBODIMENTS

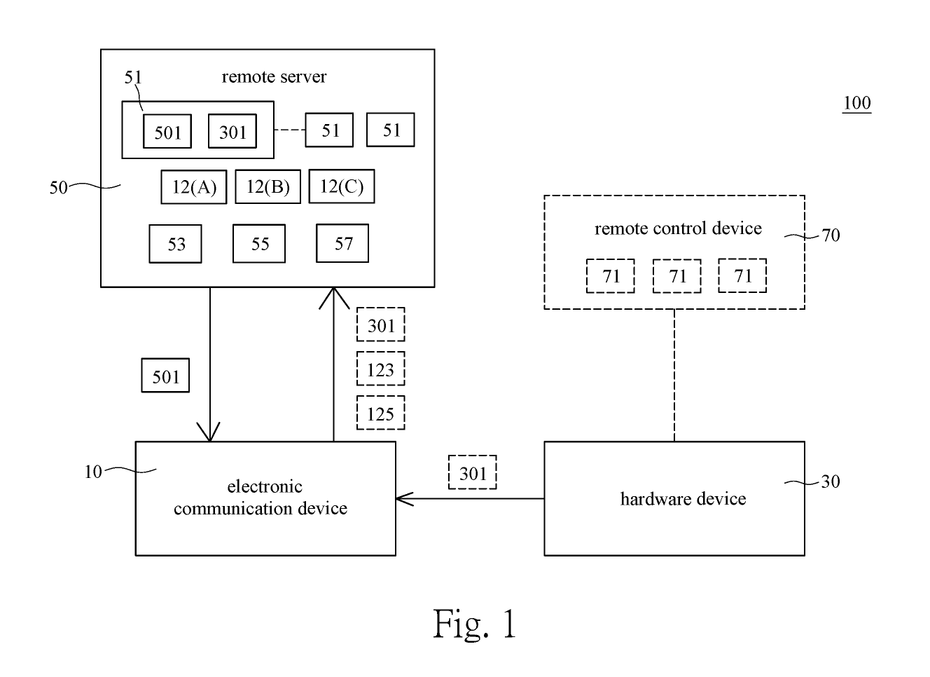

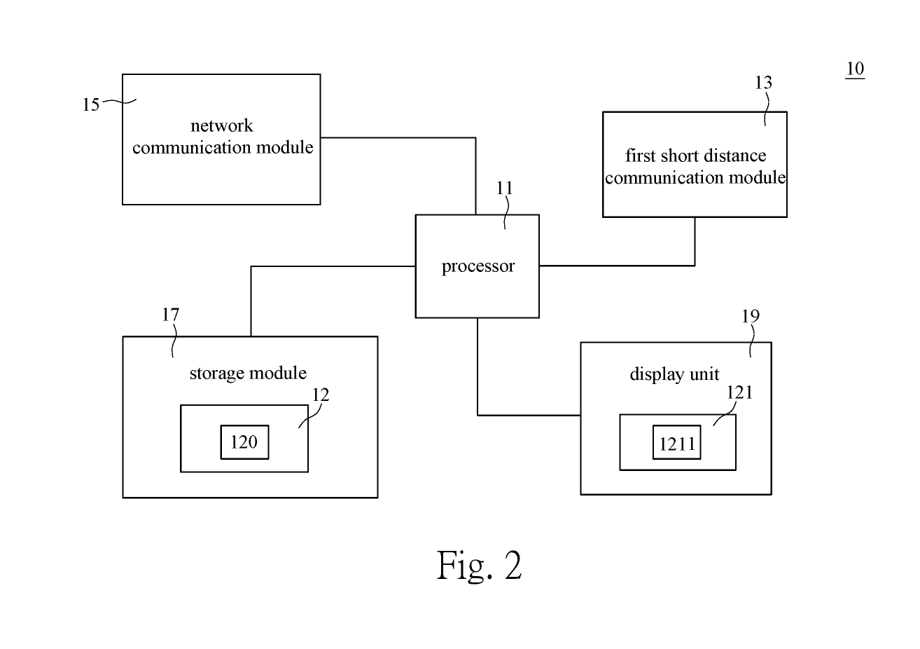

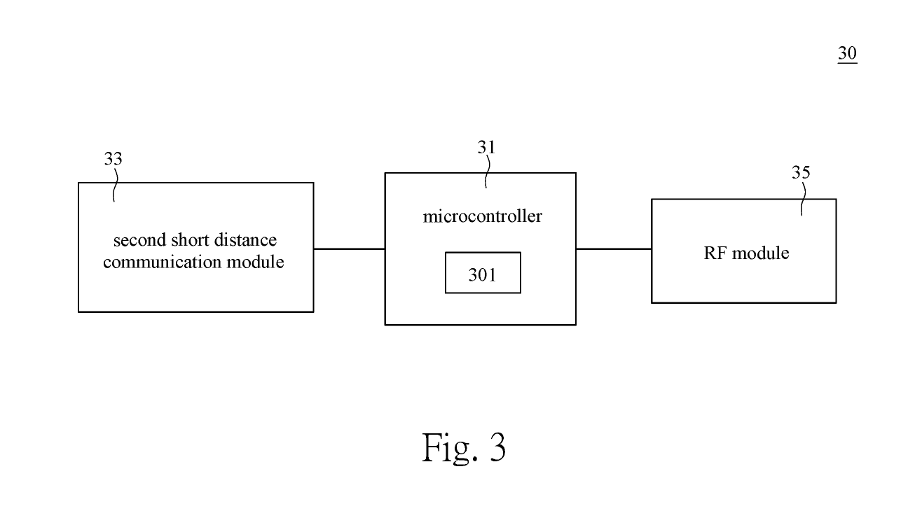

Referring to FIGS. 1, 2, and 3, there are shown a structural diagram of an internet of things system according to one embodiment of the present invention, a circuit structural diagram of an electronic communication device according to one embodiment of the present invention, and a circuit structural diagram of a hardware device according to one embodiment of the present invention. As shown in FIGS. 1, 2, and 3, the internet of things system 100 of the present invention is having the function capable of pushing message, and comprises at least one electronic communication device 10, at least one hardware device 30, and a remote server 50. The electronic communication device 10 can be a smart phone or a tablet computer, and comprises a processor 11, a first short distance communication module 13, a network communication module 15, a storage module 17, and a display unit 19. The processor 11 is connected to the first short distance communication module 13, the network communication module 15, the storage module 17, and the display unit 19, respectively. The hardware device 30 can be a self-photographing device, a smart home appliance, a Bluetooth speaker or other smart electronic device, and comprises a microcontroller 31 and a second short distance communication module 33. The microcontroller 31 is connected to the second short distance communication module 33. The remote server 50 is a network platform capable of pushing message.

The electronic communication device 10 is able to communicate with the hardware device 30 in a way of wireless connection, and installs at least one application program 12 therein. The application program 12 is capable of controlling the operation of the hardware device 30. The application program 12 is stored in the storage module 17. The storage module 17 is a data stored element, for example, flash memory element. Before the electronic communication device 10 wants to set some parameters of the hardware device 30 or control for the operation of the hardware device 30, firstly, starting the application program 12, an operation interface 121 of the application program 12 will be presented on the display unit 19. The user of the electronic communication device 10 may select a connection button 1211 on the operation interface 121, so that the application program 12 of the electronic communication device 10 will execute a short distance wireless communication connection process 120 between the first short distance communication module 13 and the second short distance communication module 33 of the hardware device 30. When the short distance wireless communication connection process 120 is complete, the wireless connection between the electronic communication device 10 and the hardware device 30 will be established, so that the user of the electronic communication device 10 can control the operation of the hardware device 30 by the use of the operation interface 121 of the application program 12. In the present invention, the first short distance communication module 13 and the second short distance communication module 33 are a Bluetooth communication module, a WiFi communication module or a component capable of short-distance communication, respectively.

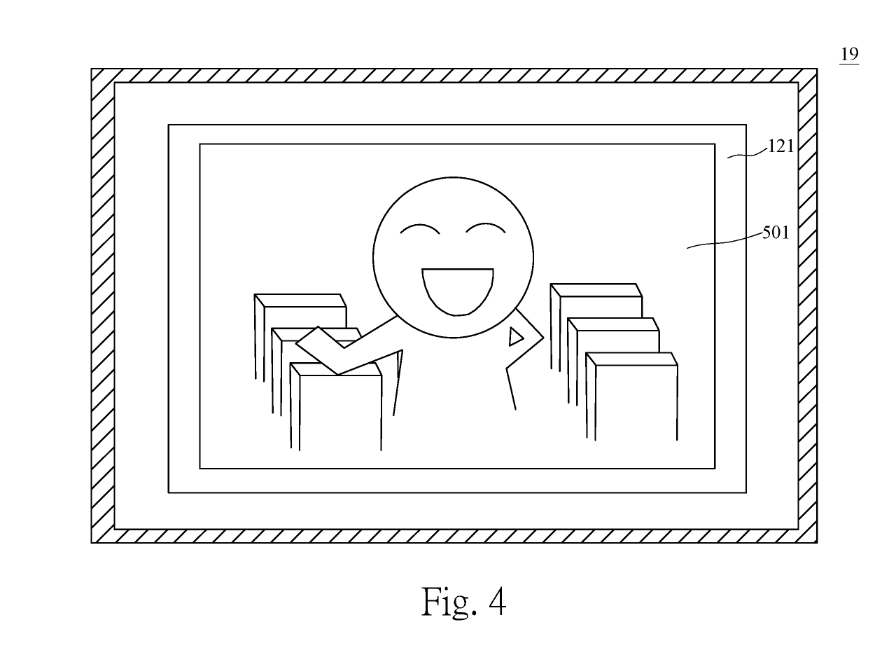

Besides, when the application program 12 is starting, the application program 12 is connected to the remote server 50 via the network communication module 15. The network communication module 15 is a 3G or 4G communication module, a WiFi communication module, or a communication module capable of connecting network. The remote server 50 comprises a message database 51 that stores a plurality of messages 501. During the execution of the wireless communication connection process 120, the remote server 50 will actively push at least one message 501 to the electronic communication device 10. The pushed message 501 can be a message of text format, sound format, or video format. The pushed message 501 will be presented on the operation interface 121 of the application program 12 of the electronic communication device 10, as shown in FIG. 4. Thus, the user of the electronic communication device can view at least one message 501 pushed by the remote server 50 before waiting for the establishment of the wireless communication connection between the electronic communication device 10 and the hardware device 30. After the wireless communication connection between the electronic communication device 10 and the hardware device 30 has been established, the remote server 50 will stop to push the message 501.

In one embodiment of the present invention, the hardware device 30 is configured with a unique identification code 301. The unique identification code 301 is a physical address of the second short distance communication module, or a product serial number of the hardware device, or an identification number written to the hardware device by a manufacturer. The hardware device 30 can be an electronic device sold by the merchant, or an electronic device presented to the consumer by the merchant. The remote server 50 is a platform for providing the merchant to push the advertisement message, each of merchants is able to establish one or more message database 51 in the remote server 50. Before the merchant sells or presents the hardware device 30 to the user of the electronic communication device 10, the merchant pre-records the unique identification code 301 into the message database 51 and pre-stores at least one advertisement message 501 into the message database 51. When the electronic communication device 10 is in executing the wireless communication connection process 120 between the electronic communication device 10 and the hardware device 30 by using the application program 12, the electronic communication device 10 will receive the unique identification code 301 sent from the hardware device 30 and transmit the unique identification code 301 to the remote server 50. When the remote server 50 receives the unique identification code 301 from the electronic communication device 10, the remote server 50 determines the corresponding message database 50 in which the received unique identification code 301 is recorded, extracts the advertisement message 501 from the corresponding message database 50 in which the received unique identification code 301 is recorded, and pushes the extracted advertisement message 501 to the electronic communication device 10 in order to play the advertisement message 501 on the operation interface 121 of the application program 12 of the electronic communication device 10. Thus, while the user waits for the establishment of the wireless connection between the electronic communication device 10 and the hardware device 30, the user of the electronic communication device 10 can watch the advertisement message 501 pushed by the remote server 50 to achieve the purpose of merchant merchandising products.

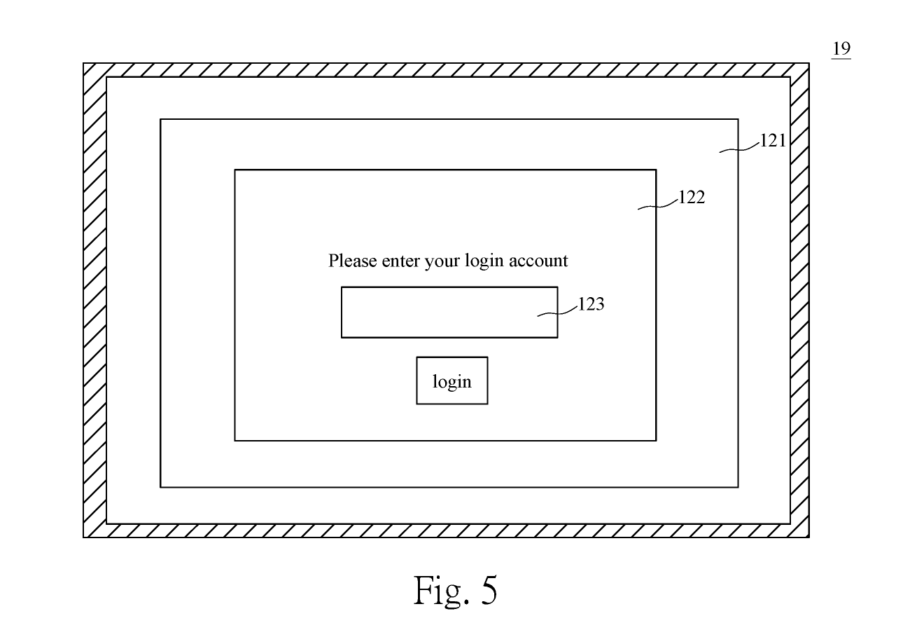

In another embodiment of the present invention, the remote server 50 further comprises a member database 53. The member database 53 records a plurality of members' identities and background information. As shown in FIG. 5, when the application program 12 of the electronic communication device 10 starts, a login screen 122 will be presented on the operation interface 121 of the application program 12, a login account 123 can be entered on the login screen 122 by the user of the electronic communication device 10 and transmitted to the remote server 50. After the remote server 50 confirms an identity and background information of the user of the electronic communication device according to the login account 123, it will allow that the application program 12 of the electronic communication device 10 can continue to perform the wireless communication connection process 120 between the electronic communication device 10 and the hardware device 30. During the wireless communication connection process 120, the remote server 50 may push at least one member message 501 to the electronic communication device 10 so that the user knows the member's rights or instructions by referring to the member message 501 before waiting of the establishment of the wireless connection between the electronic communication device 10 and the hardware device 30. During the wireless communication connection process 120, the remote server 50 may also push at least one suitable advertisement message 501 to the electronic communication device 10 according to the background information of the member so that the user views the advertisement message 501 of interest, and therefore the effect of pushing the advertisement is enhanced.

In another embodiment of the present invention, the internet of things system 100 is provided with multiple versions of the application programs, for example, the application programs (A), (B), and (C). The application program (A) of the first version is a program designed for the first merchant, the second version of application program (B) is a program designed for the second merchant, and the third version of application program (C) is a program designed for the third merchant. The user of the electronic communication device 10 can decide to download one specific version of application program (A)/(B)/(C) from the remote server 50, and install the specific version of application program (A)/(B)/(C). When the electronic communication device 10 is in executing the wireless communication connection process 120 by the use of the specific version of application program (A)/(B)/(C), the specific version of application program (A)/(B)/(C) will send a version instruction to the remote server 50. The remote server 50 can know the version of the application program 12 that is installed in the electronic communication device 10 according to the version instruction, select the message 501 to be pushed according to the version instruction, and push the selected message 501 to the electronic communication device 10.

Taking an example as description, the user of the electronic communication device 10 select the second version of application program 12 (B) to install based on member or consumer identity of the second merchant. When the second version of application program 12 (B) is in executing the wireless communication connection process 120, the second version of application program 12 (B) will send a version instruction 125 to the remote server 50. The remote server 50 can recognize that the application program 12 (B) installed in the electronic communication device 10 is the second version, and therefore select the message 501 to be pushed provided by the second merchant from the message database 51 and push the message 501 provided by the second merchant to the electronic communication device 10 so as to present the message 501 provided by the second merchant on the display unit 19 of the electronic communication device 10.

In one embodiment of the present invention, the internet of things system 100 is further configured with a business service of pushing message. The merchant uses the business service of pushing message provided by the internet of things system 100 in the way of stored value points. The remote server 50 further comprises a message pushing management module 55 and a point database 57. The message pushing management module 55 is a programming management module, which is for pushing message 501 and managing the number of times of message 501 pushed. The merchant purchases the stored value points on the internet of things system 100 in a cash payment or a mobile payment, and the stored value points will be recorded in the point database 57.

During the user of the electronic device 10 waiting for the establishment of connection of between the electronic device 10 and the hardware device 30, the message pushing management module 55 will push the advertisement message 501 of the specific merchant to the electronic communication device 10, counts the number of times of pushing the advertisement message 501 of the specific merchant, and deducts the relative stored value points of the specific merchant recorded by the point database 57 according to the number of times of pushing the advertisement message 501 of the specific merchant. For example, the advertisement message 501 was pushed once, one point will be deducted from these stored value points recorded in the point database 57. Besides, if the stored value points of the specific merchant has deducted to zero, the specific merchant must re-purchases the stored value points on the internet of things system 100; else, the message pushing management module 55 will prohibit to push the advertisement message 501 of the specific merchant. Accordingly, the merchant can achieve the purpose of convenient marketing the product in a small amount of money by the business service of pushing message provided by the internet of things system 100.

The internet of things system 100 further comprises a remote control device 70. The remote control device 70 communicates with the hardware device 30 by an RF (Radio Frequency) module 35. The remote control device 70 comprises a plurality of operation button 71. After the application program 12 of the electronic communication device 10 has established the connection between the electronic communication device 10 and the hardware device 30, the remote server 50 will stop to push the message 501. The user can control the operation of the hardware device 30 by the use of the application program 12 of the electronic communication device 10, or by the pressing of the operation button 71 on the remote control device 70.

The above disclosure is only the preferred embodiment of the present invention, and not used for limiting the scope of the present invention. All equivalent variations and modifications on the basis of shapes, structures, features and spirits described in the claims of the present invention should be included in the claims of the present invention.

1. An internet of things system for pushing message, comprising:
at least one electronic communication device comprising a processor, a first short distance communication module, a network communication module, a storage module, and a display unit, wherein the processor is connected to the first short distance communication module, the network communication module, the storage module, and the display unit, the storage module stores at least one application program, an operation interface of the application program is presented on the display unit when the application program starts;
at least one hardware device comprising a microcontroller and a second short distance communication module, wherein the microcontroller is connected to the second short distance communication module, the electronic communication device communicates with the hardware device via the first short distance communication module and the second short distance communication module, the application program of the electronic communication device is capable of controlling the operation of the hardware device; and
a remote server, wherein the electronic communication device is connected to the remote server via the network communication module;
wherein when the application program of the electronic communication device is in executing a short distance wireless communication connection process between the electronic communication device and the hardware device, at least one message will be pushed to the electronic communication device by the remote server and presented on the operation interface of the application program.

2. The internet of things system according to claim 1, wherein the hardware device is configured with a unique identification code, when the application program of the electronic communication device is in executing the short distance wireless communication connection process between the electronic communication device and the hardware device, the electronic communication device will receive the unique identification code from the hardware device and transmits the unique identification code to the remote server, the remote server will select the message to be pushed according to the unique identification code, and transmit the selected message to the electronic communication device.

3. The internet of things system according to claim 2, wherein the unique identification code is a physical address of the second short distance communication module, or a product serial number of the hardware device, or an identification number written to the hardware device by a manufacturer.

4. The internet of things system according to claim 2, wherein the remote server comprises a plurality of message databases, each of message databases records a plurality of the unique identification codes and stores the at least one message, when the remote server receives the unique identification code from the electronic communication device, the remote server will determine the corresponding message database in which the received unique identification code is recorded, extract the at least one message from the corresponding message database in which the received unique identification code is recorded, and push the extracted message to the electronic communication device.

5. The internet of things system according to claim 1, wherein the remote server comprises a member database, the member database records a plurality of members' identities and background information, when the application program of the electronic communication device starts, a login screen will be presented on the operation interface of the application program, a login account can be entered on the login screen and transmitted to the remote server, the remote server can confirm an identity and background information of the electronic communication device's user according to the login account, select the message to be pushed according to the identity and background information of the electronic communication device's user, and transmit the selected message to the electronic communication device.

6. The internet of things system according to claim 1, wherein the internet of things system is provided with multiple versions of the application programs, the electronic communication device is able to install one specific version of the application program, when the electronic communication device is in executing the short distance wireless communication connection process between the electronic communication device and the hardware device by the specific version of application program installed, the remote server will select the message to be pushed based on the application program's version installed in the electronic communication device, and push the selected message to the electronic communication device.

7. The internet of things system according to claim 1, wherein the remote server comprises a message pushing management module and a point database, the point database records stored value points of each of merchants, when the remote server pushes the at least one message of a specific merchant to the at least one electronic communication device, the message pushing management module counts the number of times of pushing the message of the specific merchant, and deducts the relative stored value points of the specific merchant in the point database according to the number of times of pushing the message of the specific merchant.

8. The internet of things system according to claim 1, wherein the message is an advertisement message or a notification message.

9. The internet of things system according to claim 1, wherein the message is a message of text format, sound format, or video format.

10. The internet of things system according to claim 1, wherein the hardware device is a self-photographing device, a smart home appliance, a Bluetooth speaker or other smart electronic device.

11. The internet of things system according to claim 1, wherein the first short distance communication module or the second short distance communication module is a Bluetooth communication module, a WiFi communication module or a component capable of short-distance communication.

12. The internet of things system according to claim 1, wherein the network communication module is a 3G or 4G communication module, a WiFi communication module, or a communication module capable of connecting network.

13. A method for pushing message, which is applied in an internet of things system, the internet of things system comprises at least one electronic communication device, at least one hardware device, and a remote server, the electronic communication device comprises a display unit and stores an application program, steps of the method for pushing message comprising:
starting the application program of the electronic communication device to present an operation interface of the application program on the display unit of the electronic communication device;
establishing a connection between the electronic communication device and the remote server in a means of network connection;
executing a short distance wireless communication connection process by the application program of the electronic communication device; and
pushing at least one message to the electronic communication device by the remote server and presenting the at least one message on the operation interface of the application program when the application program of the electronic communication device is in executing a short distance wireless communication connection process between the electronic communication device and the hardware device.

14. The method for pushing message according to claim 13, wherein the hardware device is configured with a unique identification code, the steps of the method for pushing message further comprising:
demanding the electronic communication device to receive the unique identification code from the hardware device and transmit the unique identification code to the remote server during the short distance wireless communication connection process; and
demanding the remote server to select the message to be pushed according to the unique identification code and push the selected message to the electronic communication device.

15. The method for pushing message according to claim 13, the steps of the method for pushing message further comprising:
presenting a login screen on the operation interface of the application program;
entering a login account on login screen and transmit the login account to the remote server; and
demanding the remote server to confirm an identity and background information of the electronic communication device's user according to the login account, select the message to be pushed according to the identity and background information of the electronic communication device's user, and push the selected message to the electronic communication device.

16. The method for pushing message according to claim 13, the steps of the method for pushing message further comprising:
demanding the remote server to select the message to be pushed based on the application program's version installed in the electronic communication device, and push the selected message to the electronic communication device.

17. The method for pushing message according to claim 13, the steps of the method for pushing message further comprising:
recording stored value points of a specific merchant by the remote server; and
demanding the remote server to count the number of times of pushing the message provided by the specific merchant and deducting the relative stored value points of the specific merchant according to the number of times of pushing the message of the specific merchant.
